(19) United States
(12) Patent Application Publication
(10) Pub. No.: US 2020/0090647 A1
(43) Pub. Date: Mar. 19, 2020

(54) Keyword Detection In The Presence Of Media Output

(71) Applicant: Comcast Cable Communications, LLC, Philadelphia, PA (US)

(72) Inventor: Scott David Kurtz, Mount Laurel, NJ (US)

(21) Appl. No.: 16/131,968

(22) Filed: Sep. 14, 2018

(51) Int. Cl. G10L 15/22; G10L 15/08

(52) U.S. Cl. CPC G10L 15/22; G10L 2015/088; G10L 2015/223; G10L 15/08

(57) ABSTRACT

Methods and systems are described for audio keyword detection in the presence of media playback. An example method may comprise receiving, at a first keyword detector of a device, an audio signal. The example method may comprise determining that the audio signal comprises one or more keywords. The example method may comprise sending, to a second keyword detector and based on the determining that the audio signal comprises one or more keywords, an indication to disable the second keyword detector.

### BACKGROUND

Voice activated devices may be controlled using audio inputs such as vocal instructions or utterances from a user. The voice activated device may be configured to receive an audio input comprising one or more keywords, such as trigger words or wake-up words. The one or more keywords may cause the voice activated device to perform an action, such as to output audio from one or more speakers associated with the voice activated device. However, detecting the presence of one or more keywords in an audio input may be more difficult in the presence of audio interference, such as when audio is being output by a speaker of the device or by a television in proximity to the device. Thus, improved methods for keyword detection in the presence of media playout may be desirable.

### SUMMARY

Methods and systems are disclosed for audio keyword detection. A device such as a voice activated device may comprise a speaker for outputting audio and a microphone or microphone array for detecting an audio input such as a voice command at the device. The device may increase the sensitivity of the microphone at a time when the speaker is outputting audio. This increased sensitivity may improve the probability of detecting a keyword at the microphone of the device, but may also increase the possibility of a false detection. In order to decrease the likelihood of a false detection, a first keyword detector of the device may determine whether an audio signal received at the device as an electrical signal for playout to the speaker comprises one or more keywords. Based on determining that the audio signal comprises one or more keywords, a second keyword detector for detecting one or more keywords in an audio input received at a microphone of the device may be temporarily disabled during the output of the audio signal by the device.

### BRIEF DESCRIPTION OF THE DRAWINGS

The following detailed description is better understood when read in conjunction with the appended drawings. For the purposes of illustration, examples are shown in the drawings; however, the subject matter is not limited to specific elements and instrumentalities disclosed. In the drawings:

FIG. 1 is a block diagram of an example system;

FIG. 2 shows an example operation of a voice activated system;

FIG. 3 is a flow chart of an example method;

FIG. 4 shows an example operation of a voice activated system;

FIG. 5 is a flow chart of an example method;

FIG. 6 is a flow chart of an example method;

FIG. 7 is a flow chart of an example method; and

FIG. 8 is a block diagram of an example computing device.

### DETAILED DESCRIPTION OF ILLUSTRATIVE EMBODIMENTS

Methods and systems are disclosed for audio keyword detection in the presence of media playback. A device such as a voice activated device may comprise a keyword detector configured to monitor for one or more keywords in a received audio input. Detection of the keyword, also known as a wake word or a trigger word, and an associated voice command may cause the device to perform an action associated with the voice command. A sensitivity of the keyword detector may be adjusted in order to modify the characteristics of the keyword detector. When the sensitivity of the keyword detector low, the keyword detector may have fewer false detections (e.g., detections of a keyword that was not spoken) but more misses (e.g., failures to detect a spoken keyword). When the sensitivity of the keyword detector is high, the keyword detector may have more false detections but fewer misses.

The sensitivity of the keyword detector may be increased at a time when the device is outputting audio through a speaker of the device. Increasing the sensitivity of the keyword detector may enable the keyword detector to detect a keyword that otherwise may have been missed at a lower sensitivity due to the residual interference of the audio output. However, this may also increase the chance of a false detection due to the same interference.

In order to reduce this increased likelihood of a false detection, the device may be equipped with an additional keyword detector. This additional keyword detector may analyze an audio signal received from the network prior to or simultaneous with playback of the audio signal. The audio signal may be received at the device as an electrical signal. If the additional keyword detector detects a keyword in the audio signal, than the additional keyword detector may cause the original keyword detector to be disabled for a time period. The time period may account for a finite amount of time that it takes the audio to travel through the signal processing software component in the receive direction, through the audio driver to the speaker and back from the microphone through the audio driver back to the signal processing component in the transmit direction.

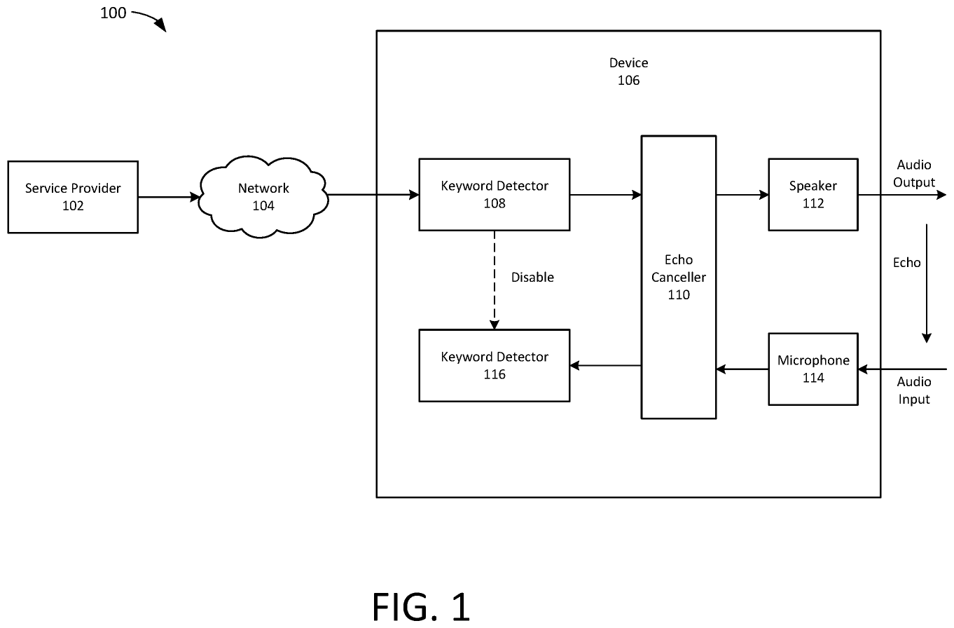

FIG. 1 shows an example system 100 in accordance with an aspect of the disclosure. The system 100 may be configured to increase the likelihood of audio keyword detection in the presence of media (e.g., audio) playback while simultaneously decreasing the likelihood of a false detection. The system 100 may comprise a service provider 102, a network 104, and a device 106.

The service provider 102 may be configured to send content to the device 106 for playback by the device 106. The content may include any type of content, including but not limited to audio and video content. The content may comprise an electrical signal capable of being processed by the device 106. The service provider 102 may be a content provider such as a cable provider, an Internet provider, a Video On Demand (VOD) provider, a music streaming service, or any type of service provider capable of providing content to the device 106 for playback by the device 106.

The network 104 may enable communication between the service provider 102 and the device 106. The service provider 102 may send one or more audio signals to the device 106 over the network 104, and may receive one or more voice commands for processing from the device 106 over the network 104. The network 104 may comprise a content delivery network, a broadband network, a telecommunications network, the Internet, or any network capable of transmitting content between two or more entities.

The device 106 may be a voice activated device configured to cause execution of a voice command. The device 106 may be configured to receive from a user of the device an audio input comprising one or more keywords and a voice command. The device may be configured to verify the voice command by using one or more of the audio fingerprinting techniques disclosed herein. Additionally or alternatively, the device may send the received audio input to a server configured to perform speech recognition processing on the audio signal. While limited speech recognition processing (e.g., audio fingerprinting) may be performed by the device in order to detect a keyword, other speech processing techniques such as pattern matching and language modeling may be performed by a server external to the device in order to determine context associated with a voice command. Based on verification of the one or more keywords, the device 106 may be configured to cause execution of the voice command associated with the one or more keywords.

The device 106 may additionally or alternatively be configured to receive as an electrical input an audio signal from the content provider 102, and may be configured to cause playback of the audio signal. The audio signal may be, for example, a music file received from a streaming service that is capable of being played back by the device 106. An electrical input may comprise one or more electrical signals that are capable of being processed by the device 106. The device 106 may comprise a first keyword detector 108, an echo canceler 110, a speaker 112, a microphone 114, and a second keyword detector 116.

The first keyword detector 108 may be configured to determine whether one or more keywords are present in an electrical signal. The electrical signal may be an audio signal received from the content provider 102 via the network 104. The first keyword detector 108 may be configured to analyze the electrical signal in order to determine whether the electrical signal comprises one or more keywords. In one example, the first keyword detector 108 may be configured to analyze a sample of the electrical signal, such as an audio fingerprint of the electrical signal. In this example, the first keyword detector 108 may be configured to sample the electrical signal at periodic intervals (e.g., every 15 milliseconds) in order to create an audio fingerprint of the electrical signal. The first keyword detector 108 may compare the audio fingerprint of the electrical signal (along with past fingerprints) with a series of audio fingerprints of one or more known keywords in order to determine whether the electrical signal comprises a known keyword. While the example above discusses the use of audio fingerprinting in signal analysis, it is understood that any other methods may be used in order to determine whether an audio signal comprises one or more keywords.

A sensitivity of the first keyword detector 108 may be adjusted in order to modify the characteristics of the first keyword detector 108. The first keyword detector 108 may be configured to determine a score associated with the likelihood that an electrical signal comprises a keyword. The first keyword detector 108 may be configured to compare this score associated with the potential keyword to a threshold. Under normal operations, an electrical signal may be determined to comprise a keyword if the score exceeds the threshold. For example, an electrical signal may be determined to comprise a keyword if the score assigned to the electrical signal exceeds a score of 5 on a scale of 1-10. The sensitivity of the first keyword detector 108 may be adjusted (e.g. increased) by lowering the threshold. Increasing the sensitivity of the first keyword detector 108 may comprise decreasing the threshold such that the electrical signal is determined to comprise a keyword if the score assigned to the electrical signal exceeds a score of 3. Additionally or alternatively, the sensitivity of the first keyword detector 108 may be decreased by increasing the threshold (e.g., a score of 7 or higher may be needed). It is understood this method of adjusting the sensitivity of the first keyword detector 108 is exemplary only and that other methods may be used.

The echo canceler 110 may be configured to reduce the likelihood that a keyword output from the speaker 112 will result in a false detection at the device 106. The echo canceler 110 may be configured to analyze a reference signal that will be output from the speaker 112 and enter the acoustic space of a room where the device 106 is located. By analyzing the reference signal that is heading to the speaker and the signal that comes in the microphone, the echo canceler 110 may generate a model of the echo path that mimics the impulse response of the acoustic path between the speaker 112 and microphone 114. The reference signal may be used by the echo canceler 110 to generate an estimate of the echo. The estimate of the echo may be subtracted from the microphone input in an attempt to cancel out the echo due to the signal coming out the speaker 112.

While the echo canceler 110 may reduce the likelihood of a false detection by subtracting the reference signal from the audio input, echo cancellation techniques may not prevent all false detections. The adaptive model generated by the echo canceler 110 may not be perfect, resulting in some amount of echo interfering with the keyword detector 116. When room conditions change (e.g., people moving around) or volume levels change, the echo estimate may differ from the actual signal received at the microphone. It is understood that the functionality of the echo canceler 110 discussed above is intended only as an example and that any type of echo cancellation technique may be used by the echo canceler 110.

The speaker 112 may be configured to output an audio signal received from the content provider 102. The audio signal may be received over the network 104 and be processed by the device 106 prior to being output by the speaker 112. The audio signal may be a music signal received from a music streaming service. The speaker 112 may additionally or alternatively be configured to output a response to a voice command received from a user of the device 106. A voice command may comprise an utterance from a user of the device, such as “how long is my commute to work?” The device may be configured to process the voice command and to output a response such as “your commute is approximately twenty minutes” through the speaker 112. Although shown as integrated into the voice activated device 106, the speaker 112 may be separate from the voice activated device 106. The speaker 112 may be integrated into a media playback device, such as a television, or may be separate from a video playback device, such as when the speaker 112 is integrated into a sound bar.

The microphone 114 may be configured to receive a voice command from a user of the device. The user may be able to power on a device, adjust channel settings, adjust volume settings, engage an advertisement, place an order, etc. via an audio input comprising one or more keywords and a voice command. Additionally or alternatively, the microphone may receive ambient audio in a room where the device 106 is located. The ambient audio may include feedback associated with audio output from the speaker 112. The voice activated device 106 may respond to an audio input based on determining that the audio input comprises one or more keywords.

The second keyword detector 116 may receive the audio input from the echo canceler 110. The audio input may comprise one or more of an utterance received from a user of the device 106 and/or ambient noise such as an output of the speaker 112 or a nearby television. The second keyword detector 116 may be configured to determine whether the audio input comprises one or more keywords. The second keyword detector 116 may use one or more speech processing techniques and/or audio fingerprinting techniques in order to determine whether the audio input comprises one or more keywords. Additionally or alternatively, the audio signal may be analyzed by a server external to the device 106 that is configured to perform speech processing. While FIG. 1 does not show a speech processing module, it is understood that a speech processing module may be implemented in the device 102, the service provider 102, an external server, and/or any other entity.

A speech processing module may comprise one or more of a speech capture module, a digital signal processor (DSP) module, a preprocessed signal storage module, and a reference speech pattern and pattern matching algorithm module. Speech processing may be done in a variety of ways and at different levels of complexity using one or more of pattern matching, pattern and feature analysis, and language modeling and statistical analysis. However, it is understood that any type of speech processing may be used, and the examples provided herein are not intended to limit the capabilities of the second keyword detector 116.

Pattern matching may comprise recognizing each word in its entirety and employing a pattern matching algorithm to match a limited number of words with stored reference speech patterns. An example implementation of pattern patching is a computerized switchboard. A person who calls a bank may encounter an automated message instructing the user to say “one” for account balance, “two” for credit card information, or “three” to speak to a customer representative. The stored reference speech patterns may comprise multiple reference speech patterns for the words “one” “two” and “three.” Thus, the computer analyzing the speech may not have to do any sentence parsing or any understanding of syntax. Instead, the entire chunk of sound may be compared to similar stored patterns in the memory.

Pattern and feature analysis may comprise breaking each word into bits and recognizing the bits from key features, such as the vowels contained in the word. Pattern and feature analysis may comprise digitizing the sound using an analog to digital converter (A/D converter). The digital data may then be converted into a spectrogram, which is a graph showing how the component frequencies of the sound change in intensity over time. This may be done using a Fast Fourier Transform (FFT). The spectrogram may be broken into a plurality overlapping acoustic frames. These frames may be digitally processed in various ways and analyzed to find the components of speech they contain. The components may then be compared to a phonetic dictionary, such as one found in stored patterns in the memory.

Language modeling and statistical analysis is a more sophisticated speech processing method in which knowledge of grammar and the probability of certain words or sounds following one from another is used to speed up recognition and improve accuracy. Complex voice recognition systems may comprise a vocabulary of over 50,000 words. Language models may be used to give context to words by analyzing the words proceeding and following the word in order to interpret different meanings the word may have. Language modeling and statistical analysis may be used to train a speech processing system in order to improve recognition of words based on different pronunciations.

The second keyword detector 116 may be configured to determine whether the audio input comprises one or more keywords using audio fingerprinting techniques. An audio fingerprint is a unique audio characteristic created based on the received audio input. The audio fingerprint may comprise a randomly selected portion of the audio input, such as a sampling of the audio input captured once every 15 milliseconds. This unique portion of the audio input may be compared to an audio fingerprint of one or more known keywords in order to determine whether the audio input comprises the one or more keywords.

While the system 100 shown in FIG. 1 shows a service provider 102, a network 104, a first keyword detector 108, an echo canceler 110, a speaker 112, a microphone 114, and a second keyword detector 116, it is understood that the system 100 is not limited to these components. The system 100 may comprise any number of the components shown and/or other components not shown in the figure.

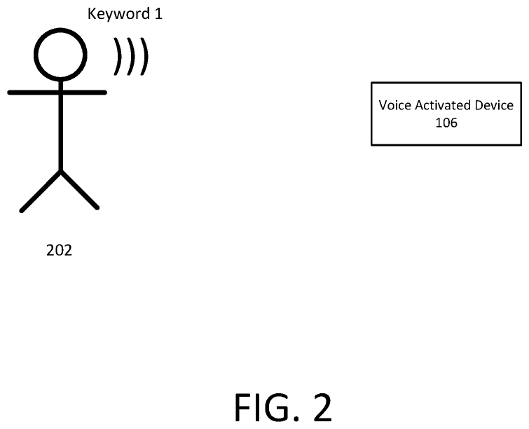

FIG. 2 shows an example operation of a voice-activated system. As shown in the figure, a user 202 of a voice activated device may utter an audio input in an area near the device. The voice activated device may be the device 106 shown in FIG. 1. The audio input may comprise a keyword (e.g., Keyword 1) and a voice command. Because the device 106 is not playing audio out of the speaker 112 of the device 106, the sensitivity of the first keyword detector 108 and the second keyword detector 116 may be adjusted to a low setting. An expectation associated with the low setting may be fewer false triggers but more potential misses. If the microphone 114 of the device 106 detects the audio input and the second keyword detector 116 recognizes the Keyword 1 uttered by the user 302, then the device 106 may perform an action based on the voice command associated with the Keyword 1. However, because the second keyword detector 116 is set to a low setting, it is possible that the Keyword 1 may remain undetected if the volume of the audio input is low or unclear. In that case, the voice command associated with the Keyword 1 may go unanswered.

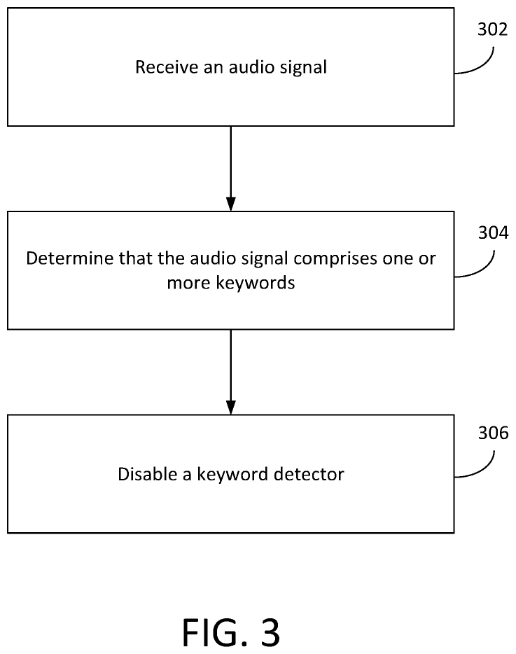

FIG. 3 shows an example method in accordance with an aspect of the disclosure. At step 302, an audio signal may be received at a device. The device may be the device 106 shown in FIG. 1. The audio signal may be received from a service provider such as the service provider 102 shown in FIG. 1. The audio signal may be received at the device as an electrical signal. The device may comprise a first keyword detector and a second keyword detector. The first keyword detector may be configured to determine whether the audio signal received at the device as an electrical signal comprises one or more keywords. The second keyword detector may be configured to determine whether an audio input received through a microphone of the device comprises one or more keywords.

At step 304, it may be determined that the audio signal comprises one or more keywords. The keywords, when detected at the device as an audio input through the microphone of the device, may cause the device to perform an action such as to output audio from the speaker of the device. In one example, the speakers may already be generating an audio output at a time when the audio input is received at the device. Thus, the device may perform an action such as to adjust a volume of the audio being output by the speaker or to stop playback of the audio.

The determination that the audio signal comprises one or more keywords may be made by the first keyword detector of the device. The first keyword detector may be configured to sample the electrical signal at periodic intervals (e.g., every 15 milliseconds) in order to create an audio fingerprint of the electrical signal. The first keyword detector may compare the audio fingerprint of the electrical signal with an audio fingerprint of one or more known keywords in order to determine whether the electrical signal comprises a known keyword.

At step 306, a keyword detector such as the second keyword detector associated with the device may be disabled. The second keyword detector may be disabled based on a determination that the audio signal comprises one or more keywords. Disabling the second keyword detector may comprise temporarily disabling the second keyword detector or disabling the second keyword detector for a determined time period. The time period may be determined based on one or more characteristics of the audio signal. The time period may be based on a length of the audio signal and/or an estimated time for the audio signal to be processed by the device, output through the speaker of the device, and received back through the microphone of the device as the audio input.

The audio signal may be output through the speaker as an audio output. Based on the audio signal being output by the speaker, a sensitivity of at least one of the first keyword detector and the second keyword detector may be adjusted. A sensitivity of the first keyword detector and the second keyword detector may be increased by lowering the threshold required for an audio signal or an audio input to comprise a keyword. Additionally or alternatively, a sensitivity of the second keyword detector may be increased such that a speech processing component associated with the device recognizes a greater number of potential keyword utterances in an audio input. While an increase in the sensitivity of the first keyword detector and the second keyword detector may allow for the possibility of a greater number of false detections, this possibility may be offset by the temporary disabling of the second keyword detector upon detection of a keyword by the first keyword detector. Additionally or alternatively, interference received at the microphone 114 from the speaker 112 may reduce the likelihood of a false detection in an audio input associated with people speaking in the room.

An audio input may be received at the device during the time period that the second keyword detector is disabled. The audio input may correspond to feedback associated with an audio output generated by the speaker of the device, or may correspond to a voice command uttered by a user of the device. The audio input, upon being detected by the microphone of the device, may be sent to the second keyword detector for processing. However, since the second keyword detector has been temporarily disabled during the time period, the audio input may be ignored. In the example that the audio input comprises an audio output generated by the speaker of the device, the device will have successfully ignored a false trigger. While it is also possible that the device may ignore a voice command intended for the device during the time period, it is unlikely that a voice command will be uttered contemporaneously with the temporary disablement of the second keyword detector.

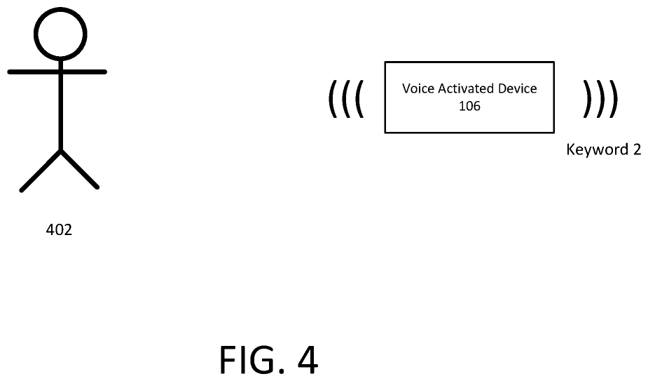

FIG. 4 shows an example operation of a voice-activated system. A voice activated device may receive an audio signal as an electrical signal from a service provider such as the service provider 102 shown in FIG. 1. The voice activated device may be the device 106 shown in FIG. 1. The first keyword detector 108 of the device may detect a keyword in the audio signal. In response to this detection, the device may temporarily disable a second keyword detector of the device configured to monitor for the presence of one or more keywords in an audio input received through a microphone of the device. Because the device 106 is currently playing audio out of the speaker 112 of the device 106, the sensitivity of the first keyword detector 108 and the second keyword detector 116 may be adjusted to a high setting. An expectation associated with the high setting may be more false triggers but fewer misses. However, since the second keyword detector 116 is disabled for the determined time period, the chances of the Keyword 2 in the outputted audio causing a false trigger are reduced or eliminated, despite the otherwise increased sensitivity of the second keyword detector 116.

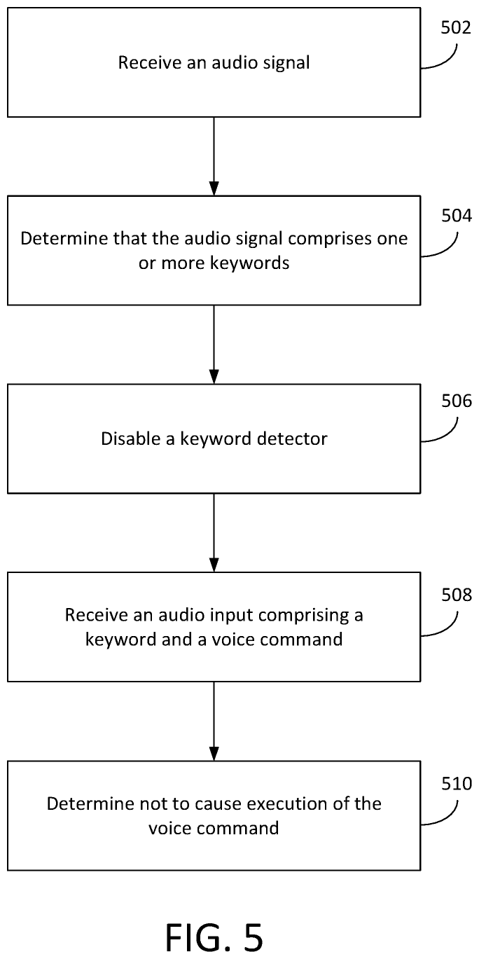

FIG. 5 shows an example method in accordance with an aspect of the disclosure. At step 502, an audio signal may be received at a device. The device may be the device 106 shown in FIG. 1. The audio signal may be received from a service provider such as the service provider 102 shown in FIG. 1. The audio signal may be received at the device as an electrical signal. The device may comprise a first keyword detector and a second keyword detector. The first keyword detector may be configured to determine whether the audio signal received at the device as an electrical signal comprises one or more keywords. The second keyword detector may be configured to determine whether an audio input received through a microphone of the device comprises one or more keywords.

At step 504, it may be determined that the audio signal comprises one or more keywords. The one or more keywords, when detected at the device as an audio input through the microphone 114 of the device, may cause the device to perform an action such as to output audio from the speaker 112 of the device. In one example, the speakers may already be generating an audio output at a time when the audio input is received at the device. Thus, the device may perform an action such as to adjust a volume of the audio being output by the speaker or to stop playback of the audio by the device.

The determination that the audio signal comprises one or more keywords may be made by the first keyword detector of the device. The first keyword detector may be configured to sample the electrical signal at periodic intervals (e.g., every 15 milliseconds) in order to create an audio fingerprint of the electrical signal. The first keyword detector may compare the audio fingerprint of the electrical signal with an audio fingerprint of one or more known keywords in order to determine whether the electrical signal comprises a known keyword.

At step 506, a keyword detector such as the second keyword detector associated with the device may be disabled. The second keyword detector may be disabled based on a determination that the audio signal comprises one or more keywords. Disabling the second keyword detector may comprise temporarily disabling the second keyword detector or disabling the second keyword detector for a determined time period. The time period may be determined based on one or more characteristics of the audio signal. The time period may be based on a length of the audio signal and/or an estimated time for the audio signal to be processed by the device, output through a speaker of the device, and received back through the microphone of the device as the audio input.

At step 508, an audio input may be received. The audio input may be received at the device, such as through a microphone of the device. The audio input may comprise feedback of the audio signal after the audio signal is output through a speaker of the device and fed back acoustically to the microphone. The audio input may comprise a keyword and a voice command. Based on the audio signal being output by the speaker, a sensitivity of at least one of the first keyword detector and the second keyword detector may be adjusted. A sensitivity of the first keyword detector and the second keyword detector may be increased by lowering the threshold required for an audio signal or an audio input to comprise a keyword. Additionally or alternatively, a sensitivity of the second keyword detector may be increased such that a speech processing component associated with the device recognizes a greater number of potential keyword utterances in an audio input. While an increase in the sensitivity of the first keyword detector and the second keyword detector may allow for the possibility of a greater number of false detections, this possibility may be offset by the temporary disabling of the second keyword detector upon detection of a keyword by the first keyword detector.

At step 510, it may be determined not to cause execution of the voice command. Under normal operation, the device may be configured to detect a keyword in a received audio input and to verify the keyword using audio fingerprinting techniques. In response to verifying the keyword, the device may be configured to cause execution of a voice command associated with the keyword. However, when the audio input is received during a time period when the second keyword detector of the device is disabled, the keyword may be ignored by the second keyword detector and the voice command may not be executed by the device. In one example, since the keyword is being ignored by the second keyword detector, the voice command may not be sent to the speech processor.

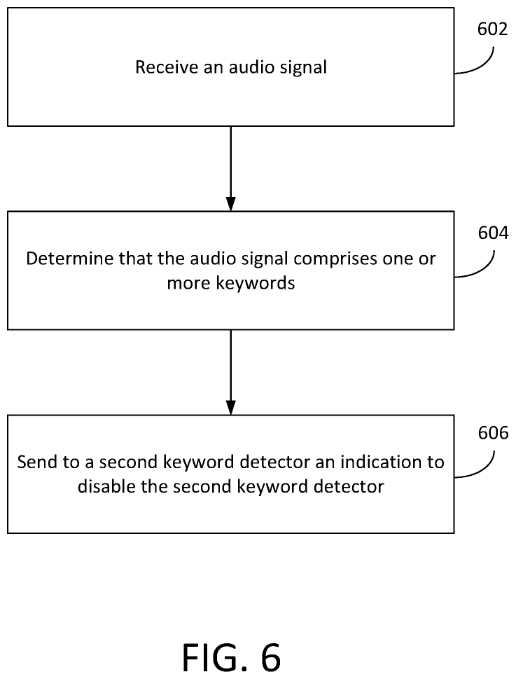

FIG. 6 shows an example method in accordance with an aspect of the disclosure. At step 602, an audio signal may be received at a device. The device may be the device 106 shown in FIG. 1. The audio signal may be received at a first keyword detector of the device, such as the first keyword detector 116 shown in FIG. 1. The audio signal may be received from a service provider such as the service provider 102 shown in FIG. 1. The audio signal may be received at the device as an electrical signal. The audio signal may be associated with audio intended to be output by the speaker of the device or by a speaker associated with another device, such as a television located in proximity to the voice activated device. The first keyword detector may be configured to determine whether the audio signal received at the device as an electrical signal comprises one or more keywords.

At step 604, it may be determined that the audio signal comprises one or more keywords. The one or more keywords, when detected at the device as an audio input through the microphone 114 of the device, may cause the device to perform an action such as to output audio from the speaker 112 of the device. In one example, the speakers may already be generating an audio output at a time when the audio input is received at the device. Thus, the device may perform an action such as to adjust a volume of the audio being output by the speaker or to stop playback of the audio by the device. Additionally or alternatively, the device in response to detection of the one or more keywords may cause a nearby device such as a television set to output the audio and/or other media.

The determination that the audio signal comprises one or more keywords may be made by the first keyword detector of the device. The first keyword detector may be configured to detect the one or more keywords in the audio signal prior to the audio signal being output by the device. The first keyword detector may be configured to sample the electrical signal at periodic intervals (e.g., every 15 milliseconds) in order to create an audio fingerprint of the electrical signal. The first keyword detector may compare the audio fingerprint of the electrical signal with an audio fingerprint of one or more known keywords in order to determine whether the electrical signal comprises a known keyword.

At step 606, the first keyword detector may send to a second keyword detector an indication to disable the second keyword detector. The second keyword detector may be configured to determine whether an audio input received through a microphone of the device comprises one or more keywords. The second keyword detector may be disabled based on a determination by the first keyword detector that the audio signal comprises one or more keywords. Disabling the second keyword detector may comprise temporarily disabling the second keyword detector or disabling the second keyword detector for a determined time period. The time period may be determined based on one or more characteristics of the audio signal. The time period may be based on a length of the audio signal and/or an estimated time for the audio signal to be processed by the device, output through a speaker of the device, and received back through the microphone of the device as the audio input.

The device may be configured to cause output of the audio signal. The audio signal may be output through a speaker of the device, such as the speaker 112 shown in FIG. 1. The audio signal may be output through the speaker as an audio output. Based on the audio signal being output by the speaker, a sensitivity of at least one of the first keyword detector and the second keyword detector may be adjusted. A sensitivity of the first keyword detector and the second keyword detector may be increased by lowering the threshold required for an audio signal or an audio input to comprise a keyword. Additionally or alternatively, a sensitivity of the second keyword detector may be increased such that a speech processing component associated with the device recognizes a greater number of potential keyword utterances in an audio input. While an increase in the sensitivity of the first keyword detector and the second keyword detector may allow for the possibility of a greater number of false detections, this possibility may be offset by the temporary disabling of the second keyword detector upon detection of a keyword by the first keyword detector. If an audio input comprising a keyword and a voice command is received at the device during the time period, the keyword may remain undetected and the voice command may be ignored.

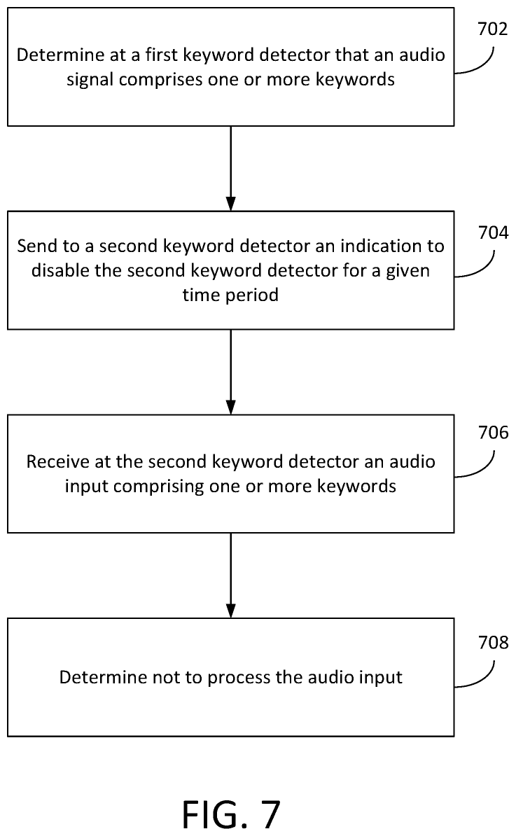

FIG. 7 shows an example method in accordance with an aspect of the disclosure. At step 702, it may be determined that an audio signal comprises one or more keywords. The audio signal may be received at a device such as the device 106 shown in FIG. 1. The audio signal may be received from a service provider such as the service provider 102 shown in FIG. 1. The determination that the audio signal comprises one or more keywords may be made by a first keyword detector, such as the first keyword detector 116 shown in FIG. 1. The audio signal may be received at the device as an electrical signal. The audio signal may be associated with audio intended to be output by the speaker of the device or by a speaker associated with another device, such as a television located in proximity to the voice activated device. The first keyword detector may be configured to determine whether the audio signal received at the device as an electrical signal comprises one or more keywords.

The keywords, when detected at the device as an audio input through the microphone 114 of the device, may cause the voice activated device to perform an action such as to output audio from the speaker 112 of the device. In one example, the speakers may already be generating an audio output at a time when the audio input is received at the device. Thus, the device may perform an action such as to adjust a volume of the audio being output by the speaker or to stop playback of the audio by the device. Additionally or alternatively, the device in response to detection of the one or more keywords may cause a nearby device such as a television set to output the audio and/or other media.

The first keyword detector may be configured to detect one or more keywords in the audio signal prior to the audio signal being output by the device. The first keyword detector may be configured to sample the electrical signal at periodic intervals (e.g., every 15 milliseconds) in order to create an audio fingerprint of the electrical signal. The first keyword detector may compare the audio fingerprint of the electrical signal with an audio fingerprint of one or more known keywords in order to determine whether the electrical signal comprises a known keyword.

At step 704, the first keyword detector may send to a second keyword detector an indication to disable the second keyword detector. The second keyword detector may be configured to determine whether an audio input received through a microphone of the device comprises one or more keywords. The second keyword detector may be disabled based on a determination that the audio signal comprises one or more keywords. Disabling the second keyword detector may comprise temporarily disabling the second keyword detector or disabling the second keyword detector for a determined time period. The time period may be determined based on one or more characteristics of the audio signal. The time period may be based on a length of the audio signal and/or an estimated time for the audio signal to be processed by the device, output through a speaker of the device, and received back through the microphone of the device as the audio input.

At step 706, an audio input may be received. The audio input may be received at the second keyword detector. The audio input may comprise feedback associated with the audio signal after the audio signal is output through the speaker of the device. The audio input may comprise a keyword and a voice command. Based on the audio signal being output by the speaker, a sensitivity of at least one of the first keyword detector and the second keyword detector may be adjusted. A sensitivity of the first keyword detector and the second keyword detector may be increased by lowering the threshold required for an audio signal or an audio input to comprise a keyword. Additionally or alternatively, a sensitivity of the second keyword detector may be increased such that a speech processing component associated with the device recognizes a greater number of potential keyword utterances in an audio input. While an increase in the sensitivity of the first keyword detector and the second keyword detector may allow for the possibility of a greater number of false detections, this possibility may be offset by the temporary disabling of the second keyword detector upon detection of a keyword by the first keyword detector.

At step 708, it may be determined not to cause execution of the voice command. Under normal operation, the device may be configured to detect a keyword in a received audio input and to verify the keyword using audio fingerprinting techniques. In response to verifying the keyword, the device may be configured to cause execution of a voice command associated with the keyword. However, when the audio input is received during a time period when the second keyword detector of the device is disabled, the keyword may be ignored by the second keyword detector and the voice command may not be executed by the device. In one example, since the keyword is being ignored by the second keyword detector, the voice command may not be sent to the speech processor.

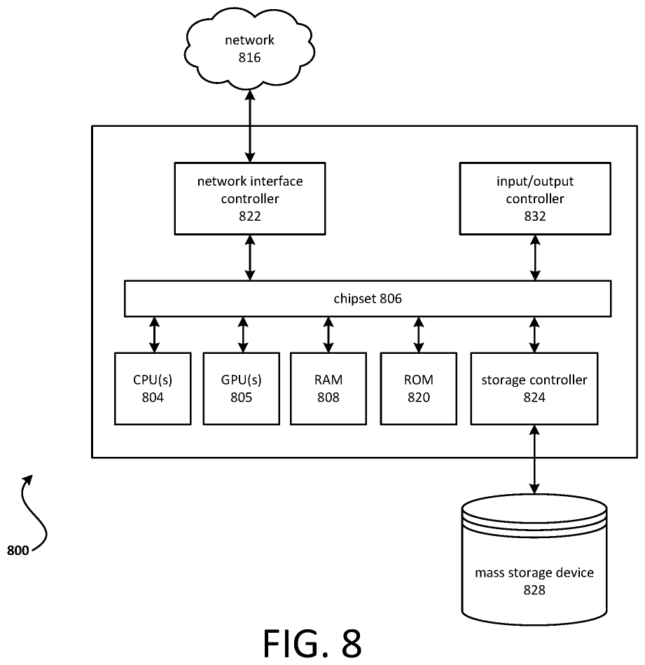

FIG. 8 depicts a computing device that may be used in various aspects, such as the servers, modules, and/or devices depicted in FIGS. 1, 2 and 4. With regard to the example architecture of FIG. 1, the user device 102, server 120, and/or the playback device 130 may each be implemented in an instance of a computing device 800 of FIG. 8. The computer architecture shown in FIG. 8 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 3 and 5-7.

The computing device 800 may include a baseboard, or “motherboard,” which is a printed circuit board to which a multitude of components or devices may be connected by way of a system bus or other electrical communication paths. One or more central processing units (CPUs) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s) 805. The GPU(s) 805 may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random access memory (RAM) 708 used as the main memory in the computing device 800. The chipset 806 may provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems through local area network (LAN) 816. The chipset 806 may include functionality for providing network connectivity through a network interface controller (NIC) 822, such as a gigabit Ethernet adapter. A NIC 822 may be capable of connecting the computing device 800 to other computing nodes over a network 816. It should be appreciated that multiple NICs 822 may be present in the computing device 800, connecting the computing device to other types of networks and remote computer systems.

The computing device 800 may be connected to a mass storage device 828 that provides non-volatile storage for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may read information from the mass storage device 828 by detecting the physical states or characteristics of one or more particular locations within the physical storage units.

In addition to the mass storage device 828 described herein, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described herein. The computing device 800 may have access to computer-readable storage media storing computer-executable instructions, which, when executed by the computing device 800, may perform the methods described in relation to FIGS. 3 and 5-7.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
receiving, by a device, an audio signal;
causing, during output of the audio signal via the device, a change in a sensitivity of detection, via the device, of one or more keywords;
determining that an audio input received via the device comprises the one or more keywords; and
causing, based on the determining that the audio input comprises the one or more keywords, the device to perform an action.

2. The method of claim 1, further comprising:
determining that the received audio signal comprises the one or more keywords; and
based on the determining that the received audio signal comprises the one or more keywords, causing disablement, for a time period during output of the audio signal, of detection of the one or more keywords.

3. The method of claim 2, further comprising:
receiving, during the time period, an other audio input comprising the one or more keywords; and
causing the device not to process the other audio input.

4. (canceled)

5. The method of claim 3, wherein the other audio input comprises feedback of the audio signal during output of the audio signal via the device.

6. (canceled)

7. The method of claim 1, wherein causing the change in the sensitivity of detection of the one or more keywords comprises causing an increase in the sensitivity of detection of the one or more keywords.

8. The method of claim 1, wherein the audio input further comprises a voice command, and wherein causing the device to perform an action comprises causing the device to perform an action associated with the voice command.

9-11. (canceled)

12. The method of claim 2, wherein the time period is determined based on an output time of the audio signal and an estimated time for receipt of the corresponding audio input.

13-20. (canceled)

21. The method of claim 1, wherein causing the change in the sensitivity of detection of one or more keywords comprises causing a change in a threshold to which a score associated with detection of the one or more keywords is compared.

22. A device comprising:
one or more processors; and
memory storing instructions that, when executed by the one or more processors, cause the device to:
receive an audio signal;
cause, during output of the audio signal via the device, a change in a sensitivity of detection, via the device, of one or more keywords;
determine that an audio input received via the device comprises the one or more keywords; and
cause, based on the determining that the audio input comprises the one or more keywords, an action to be performed.

23. The device of claim 22, wherein the instructions further cause the device to:
determine that the received audio signal comprises the one or more keywords; and
based on the determining that the received audio signal comprises the one or more keywords, cause disablement, for a time period during output of the audio signal, of detection of the one or more keywords.

24. The device of claim 23, wherein the instructions further cause the device to:
receive, during the time period, an other audio input comprising the one or more keywords; and
cause the device not to process the other audio input.

25. The device of claim 24, wherein the other audio input comprises feedback of the audio signal during output of the audio signal via the device.

26. The device of claim 23, wherein the device further comprises a keyword detector, and wherein determining that the audio signal comprises the one or more keywords comprises determining, by the keyword detector, that the audio signal comprises the one or more keywords.

27. The device of claim 22, wherein causing the change in the sensitivity of detection of the one or more keywords comprises causing an increase in the sensitivity of detection of the one or more keywords.

28. The device of claim 22, wherein causing the change in the sensitivity of detection of one or more keywords comprises causing a change in a threshold to which a score associated with detection of the one or more keywords is compared.

29. The device of claim 22, wherein the audio input further comprises a voice command, and wherein causing an action to be performed comprises causing the device to perform an action associated with the voice command.

30. A non-transitory computer-readable storage medium storing instructions that, when executed, cause:
receiving, by a device, an audio signal;
causing, during output of the audio signal via the device, a change in a sensitivity of detection, via the device, of one or more keywords;
determining that an audio input received via the device comprises the one or more keywords; and
causing, based on the determining that the audio input comprises the one or more keywords, the device to perform an action.

31. The non-transitory computer-readable storage medium of claim 30, wherein the instructions further cause:
determining that the received audio signal comprises the one or more keywords; and
based on the determining that the received audio signal comprises the one or more keywords, causing disablement, for a time period during output of the audio signal, of detection of the one or more keywords.

32. The non-transitory computer-readable storage medium of claim 31, wherein the instructions further cause:
receiving, during the time period, an other audio input comprising the one or more keywords; and
causing the device not to process the other audio input.

33. The non-transitory computer-readable storage medium of claim 30, wherein causing the change in the sensitivity of detection of the one or more keywords comprises causing an increase in the sensitivity of detection of the one or more keywords.

34. The non-transitory computer-readable storage medium of claim 30, wherein causing the change in the sensitivity of detection of one or more keywords comprises causing a change in a threshold to which a score associated with detection of the one or more keywords is compared.
